(19) United States
(12) Patent Application Publication
(10) Pub. No.: US 2025/0156910 A1
(43) Pub. Date: May 15, 2025

(54) SYSTEMS AND METHODS FOR USER TRACKING DASHBOARD GENERATION

(71) Applicant: Wells Fargo Bank, N.A., San Francisco, CA (US)

(72) Inventor: Cathy Ann Costa, Walnut Creek, CA (US)

(21) Appl. No.: 18/055,296

(22) Filed: Nov. 14, 2022

(51) Int. Cl. G06Q 30/0279; G06Q 30/0207

(52) U.S. Cl. CPC G06Q 30/0279; G06Q 30/0219

(57) ABSTRACT

A method may include presenting a goal creation user interface on a client device to a user including: a label input element configured to receive an identifier for a goal; a total amount input element configured to receive a total amount of the goal; and a milestone input element configured to receive a milestone amount that is less than the total amount; generating a goal data structure based on values of the label input element, input element, and the milestone input; matching a sponsor identifier to the goal data structure; updating the goal data structure to include the sponsor identifier; presenting a goal status user interface, the goal status user interface including a graphic associated with the sponsor identifier; receiving an indication that the milestone amount has been reached; and updating the goal status user interface to include a link to an award associated with the sponsor identifier.

### BACKGROUND

Electronic systems have enabled a more streamlined version of goal tracking for users. For example, a user may utilize goal tracking software that integrates with their financial institution to set aside a certain amount of money every week. Or a retirement account may help a user determine if they are on track to retire by a certain age.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawing.

FIG. 1 is an illustration of components of a client device and an application server, according to various examples.

FIG. 2 is a goal creation user interface, according to various examples.

FIG. 3 is a goal matching user interface, according to various examples.

FIG. 4 is a goal status user interface, according to various examples.

FIG. 5 illustrates an aspect of the subject matter in accordance with one embodiment.

FIG. 6 is a block diagram illustrating a machine in the example form of computer system 600, within which a set or sequence of instructions may be executed to cause the machine to perform any one of the methodologies discussed herein, according to various examples.

### DETAILED DESCRIPTION

In the following description, for purposes of explanation, numerous specific details are set forth to provide a thorough understanding of some example embodiments. It will be evident, however, to one skilled in the art that the present invention may be practiced without these specific details.

Throughout this disclosure, electronic actions may be performed by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a certain purpose. For example, an input element may be described as configured to receive an input string. In this context, “configured to” may mean presentation of a user interface element that is capable of receiving user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query with respect to a database.

Although a user may create and have many goals, user interfaces that help them monitor their progress are often textual or overly complex. Additionally, many goals (e.g., saving for a car purchase) are solitary in nature—e.g., the person has no one else to encourage them to keep their goal. This may lead to the user does not accomplish their goal or even create a goal in the first place.

There may be companies that would like to help a user meet their goal, but data privacy concerns of the user may restrict access to the user. For example, a real estate company may want to sponsor a down payment savings goal of the user, but have no way to know the user even has such a goal. Thus, there is a technical problem of matching users to potential sponsors.

In various examples, systems and methods described herein provide improvements over existing goal systems. For example, computer-based goal management systems lack the user interfaces and capabilities of matching goals with sponsors as described herein. Furthermore, the systems and methods promote data privacy by allowing sponsorship of a goal without divulging personally identifiable information (PII) of the user that created the goal.

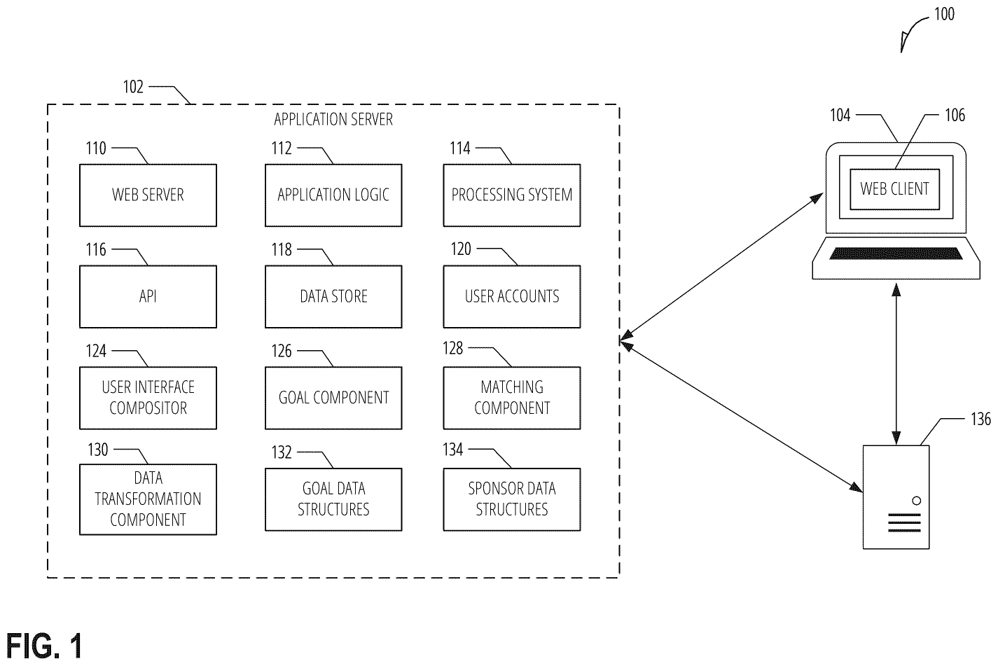

FIG. 1 is an illustration of components of a client device and an application server, according to various examples. FIG. 1 includes an application server 102, a client device 104, a web client 106, a web server 110, an application logic 112, a processing system 114, an API 116, a data store 118, user accounts 120, a user interface compositor 124, a goal component 126, a matching component 128, a data transformation component 130, goal data structures 132, and sponsor data structures 134.

Application server 102 is illustrated as set of separate elements (e.g., components, logic, etc.). However, the functionality of multiple, individual elements may be performed by a single element. An element may represent computer program code that is executable by processing system 114. The program code may be stored on a storage device (e.g., data store 118) and loaded into a memory of the processing system 114 for execution. Portions of the program code may be executed in a parallel across multiple processing units (e.g., a core of a general-purpose computer processor, a graphical processing unit, an application specific integrated circuit, etc.) of processing system 114. Execution of the code may be performed on a single device or distributed across multiple devices. In some examples, the program code may be executed on a cloud platform (e.g., MICROSOFT AZURE® and AMAZON EC2®) using shared computing infrastructure.

Client device 104 (and sponsor computing device 136) may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

Client device 104, application server 102, and sponsor computing device 136 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks, or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet

In some examples, the communication may occur using an application programming interface (API) such as API 116. An API provides a method for computing processes to exchange data. A web-based API (e.g., API 116) may permit communications between two or more computing devices such as a client and a server. The API may define a set of HTTP calls according to Representational State Transfer (RESTful) practices. For examples, A RESTful API may define various GET, PUT, POST, DELETE methods to create, replace, update, and delete data stored in a Database (e.g., data store 118). For example, application server 102 may implement an API call to create or edit a goal as a goal data structure in goal data structures 132. Another API call may be used to define sponsor rules using a sponsor data structure in sponsor data structures 134. Yet another API call may obfuscate goal data of a goal. The implementation of creating a goal, defining sponsor rules, and data obfuscation are discussed in more detail below.

Application server 102 may include web server 110 to enable data exchanges with client device 104 via web client 106. Although generally discussed in the context of delivering webpages via the Hypertext Transfer Protocol (HTTP), other network protocols may be utilized by web server 110 (e.g., File Transfer Protocol, Telnet, Secure Shell, etc.). A user may enter in a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page that is rendered on a display device of a client device (e.g., a mobile phone, desktop computer, etc.).

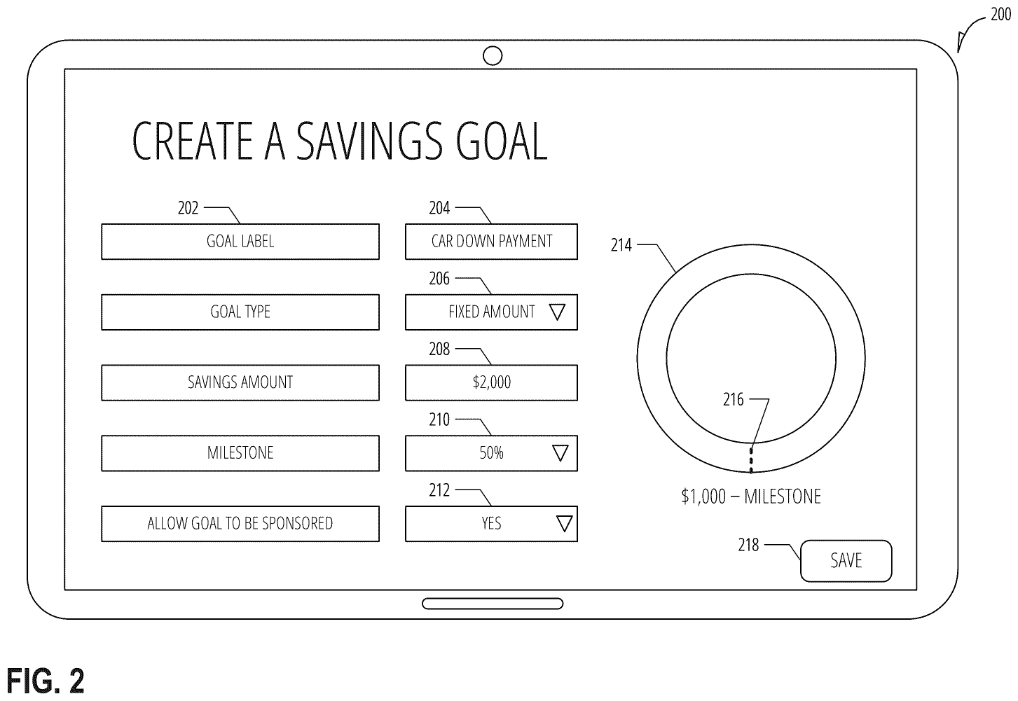

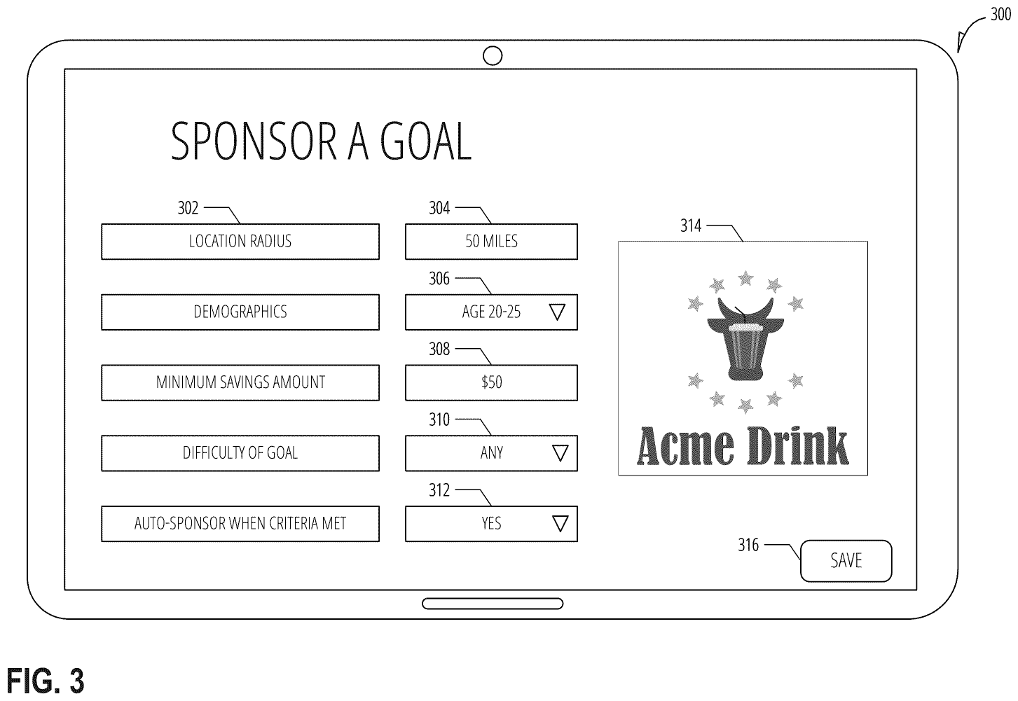

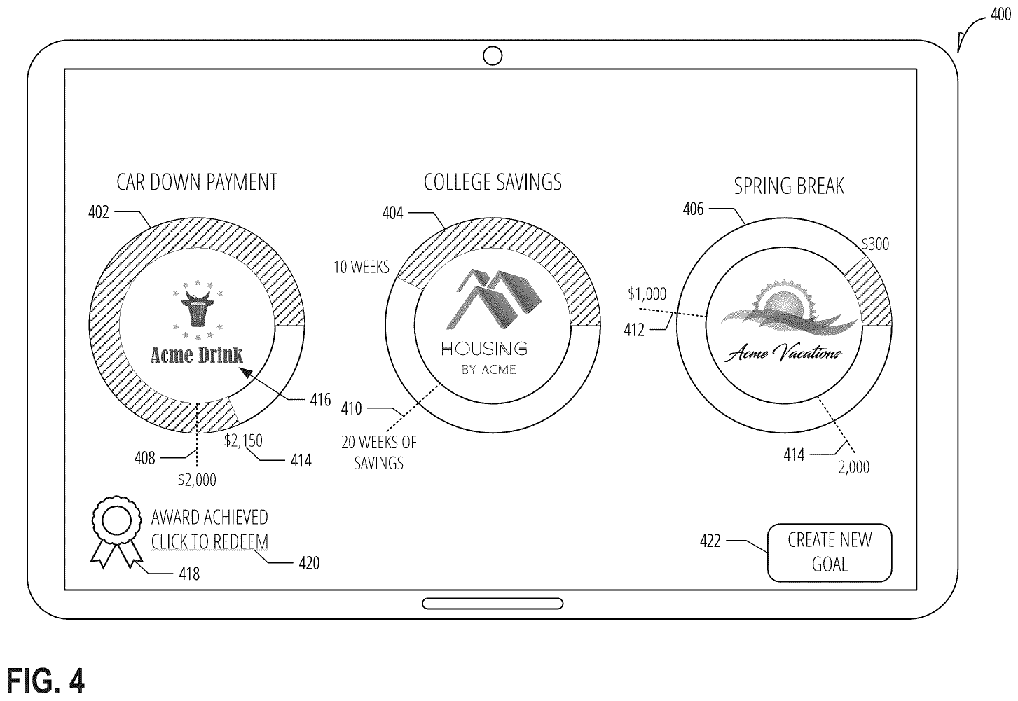

Additionally, web server 110 may enable a user to interact with one or more web applications provided in a transmitted web page. A web application may provide user interface (UI) components (as determined by user interface compositor 124) that are rendered on a display device of client device 104. The user may interact (e.g., select, move, enter text into) with the UI components, and based on the interaction, the web application may update one or more portions of the web page. A web application may be executed in whole, or in part, locally on client device 104. The web application may populate the UI components with data from external sources or internal sources (e.g., data store 118) in various examples. In various examples, the web application provides user interface elements to a user to create a goal and view progress of those goals. These aspects are discussed more in the context of FIG. 2 and FIG. 4. The web application may also provide functionality to a sponsor (e.g., via sponsor computing device 136) to define sponsorship matching rules. These rules are discussed in more detail in the context of FIG. 3.

The web application may be executed according to application logic 112. Application logic 112 may use the various elements of application server 102 to implement the web application. For example, application logic 112 may issue API calls to retrieve or store data from data store 118 and transmit it for display on client device 104 such as goal descriptions or sponsor rules. Similarly, data entered by a user into a UI component may be transmitted using API 116 back to the web server. Application logic 112 may use other elements (e.g., user interface compositor 124, goal component 126, matching component 128, etc.) of application server 102 to perform functionality associated with the web application as described further herein.

Data store 118 may store data that is used by application server 102. Data store 118 is depicted as singular element but may in actuality be multiple data stores. The specific storage layout and model used in by data store 118 may take a number of forms—indeed, a data store 118 may utilize multiple models. Data store 118 may be, but is not limited to, a relational database (e.g., SQL), non-relational database (NoSQL) a flat file database, object model, document details model, graph database, shared ledger (e.g., blockchain), or a file system hierarchy. Data store 118 may store data on one or more storage devices (e.g., a hard disk, random access memory (RAM), etc.). The storage devices may be in standalone arrays, part of one or more servers, and may be located in one or more geographic areas.

For example, data store 118 may store sponsor data structures 134 and goal data structures 132. A sponsor data structure may include a sponsor identifier, one or more sponsor rule identifiers, and associated sponsoring criteria for the sponsor rule identifiers. A goal data structure may include a user identifier, a total amount, a milestone amount, and a sponsor identifier.

Data structures may be implemented in several manners depending on a programming language of an application or database management system used by an application. For example, if C++ is used, the data structure may be implemented as a struct or class. In the context of a relational database, a data structure may be defined in a schema.

User accounts 120 may include user profiles on users of application server 102. A user profile may include credential information such as a username and hash of a password. A user may enter in their username and plaintext password to a login page of application server 102 to view their user profile information or interfaces presented by application server 102 in various examples. Different types of users may have different interfaces presented. For distinguishing purposes, a goal user may be a user that is creating a goal and a sponsor user may be a user that creates sponsoring criteria. In various examples, a goal user may have an account at a financial institution. The financial institution may operate application server 102. Accordingly, a user account of a goal user may have one or more accounts with the financial institution and associated balances.

A user account may also include preferences of the user. The preferences may include default preferences on if a goal should be sponsored or not. Additionally, the preferences may identify what level of data access a potential sponsor should have with respect to a goal. The level of access may indicate what categories of data and a level of detail a sponsor may have access to for each category. For example, categories may include a goal amount, personal details (e.g., age, occupation), residence address. Levels may include no access, obfuscation access, or full access. Obfuscation access may allow a generalized form of the information such as an age rage, a 50-mile radius location, etc.

Goal component 126 may include logic to create a goal data structure. For example, a user interface may be presented to a user to input various characteristics of the goal such as the goal amount, a goal label, a milestone amount, etc. After entry of the information, goal component 126 may generate a goal data structure based on the inputted information and save it to data store 118.

Goal component 126 may also update a savings account of a user based on the created goal. For example, when a new goal is created, an update to the savings account may be made to a database that indicates the label of the created goal. Then when a user navigates to an overview of their savings account, the user may be able to see the current amount saved for that goal (e.g., a separate line under the overall balance). Similarly, a user may transfer money to the goal as if it was its own account. In various examples, a single savings account exists, but is virtually segmented to allow for the user to set aside money for the goals.

Goal component 126 may also monitor the progress of the goal. For examples, when a user reaches a savings milestone amount, an API call may be made to matching component 128 to determine if a reward from a sponsor should be received. A reward (e.g., a coupon from the sponsor, etc.) message may be presented to the user on their account page with a link to the award. In various examples, the sponsor may contact the user directly, via an email address, with the award.

Matching component 128 may include logic to match a created goal to a sponsor. The algorithm may be triggered when a new goal data structure is created. Data in the new goal data structure may be accessed and compared to the sponsoring criteria of sponsor rule identifiers in sponsor data structure. For example, assuming the goal data structures are stored in a relational database, a structured query language (SQL) query may be executed with search criteria matching the accessed values of the goal data structure. In response, one or more sponsor rule identifiers may be received. When more than one match is made, matching component 128 may be configured to randomly select one. In other examples, a goal may have multiple sponsors. Before sponsoring criteria is used to match a sponsor to a user goal, data transformation component 130 may transform the data to the level of access as determined by the user preferences. For example, matching component 128 may return a set of goals that match the sponsoring criteria, but not any user information.

FIG. 2 is a goal creation user interface 200, according to various examples. FIG. 2 includes an input field identifier 202, a label input element 204, a goal type input element 206, a total amount input element 208, a milestone input element 210, a sponsor authorization input element 212, a goal visualization 214, a goal milestone marker 216, and a save element 218. Interface 200 may be presented after a goal user has logged into application server 102 using their credentials. Upon logging in, an account overview page may be presented with a UI element to create a new goal.

Interface 200 may include field identifier labels indicating what input the user should place in the adjacent input element. For example, input field identifier 202 is labeled “goal label” indicating that the user should enter in a name into label input element 204. Label input element 204 may be used as an internal identifier of a goal data structure with respect to the logged in user. In various examples, label input element 204 may be configured as a drop-down menu that lists possible goal labels such as “college savings” or “house down payment.”

Goal type input element 206 may be used to select either a fixed amount goal or a periodic savings goal. A periodic savings goal may be to save an amount of money for 20 weeks—consecutive or non-consecutive. The two types may also be combined such that a goal is to save $20 a week for 20 weeks.

total amount input element 208 may be used to input a value based on the selection in goal type input element 206. For a fixed amount, the input may be a single value. For a periodic savings goal, multiple total amount input elements 208 may be presented—one for the number of weeks and optionally one for an amount.

Milestone input element 210 may be used to identify an interim milestone that is less than the total amount (or total number of weeks). Milestone input element 210 may be configured as a percentage or a nominal amount. Although not shown, a user may define more than one milestone per goal.

Sponsor authorization input element 212 is configured to authorize sponsoring of the goal. If the user selects “no” then no user information or goal information is permitted to be used outside of the user and financial institution.

A goal data structure may be algorithmically assigned a difficulty level (e.g., zero being easy and five being hard) based on the values of the input elements in interface 200. An initial difficulty value may be set according to the value in label input element 204. For example, a “college savings” goal may correspond to a level three difficulty—whereas a car down payment may be a two. Weights may be applied to the initial value based on the total amount input element 208. For example, if the savings amount is over a predetermined amount the difficulty may be multiplied by a value greater than one. Similarly, when the savings amount is less than a predetermined amount, the initial value may be multiplied by a value less than one.

A user may activate save element 218 to create the goal. Upon activation, a goal data structure may be stored as in data store 118 according to the values in interface 200 and the determined difficulty level. The goal data structure may be associated (e.g., an identifier of the goal and identifier of the user are linked) with the identification of the currently logged in user.

Goal visualization 214 may represent a potential visualization of the goal as it may appears on a goal status user interface. In the illustrated example, an outer portion of a ring is used to represent the status of the goal. Goal milestone marker 216 may be a visual dissection of the outer portion of the ring with a label indicating the milestone amount. The location of goal milestone marker 216 may also correspond to the milestone amount. Thus, a 50% milestone would be at the 180-degree portion of the circle (and a 75% milestone would be at 270 degrees, etc.).

In various examples, user interface compositor 124 is used to generate goal visualization 214 according to a set of stored preferences of the user of an administrative user. For example, different visualization shapes may be used such as squares, triangles, etc., in which an outer portion is filled in as a user progresses with meeting the goal the visualization shape. A visualization shape may include an empty portion inside of the shape to permit a sponsor graphic to be presented inside.

FIG. 3 is a goal matching user interface 300, according to various examples. Interface 300 includes an input field identifier 302, a location input element 304, a demographic input element 306, a minimum amount input element 308, a difficulty selection input element 310, an auto-sponsor preference element 312, a sponsor graphic 314, and a save element 316.

The goal matching user interface 300 may be used to input preferences with respect to sponsoring criteria (e.g., matching rules). The user entering in information into the interface 300 may be a user of a sponsor entity (e.g., a company). For example, the sponsor user may log in to application server 102 and be presented with a list of previously created sponsorship rules (as retrieved from data store 118), and an option to create another rule.

Interface 300 may include field identifier labels indicating what input the user should place in the adjacent input element. For example, input field identifier 302 is labeled “location radius” indicating that the user should enter in a distance to location input element 304. The distance may correspond to a radius with respect to the user that created the goal. For example, if the user is within the radius, then the criterion is determined to be met. To ensure that the goal user's privacy is maintained, the sponsor entity may not be able to view the actual location of the goal user. Instead, application server 102 may perform the comparison between a set of addresses, cities, etc., provided by sponsor user and the location of the goal user determined by the goal user's profile (e.g., as stored in user accounts 120). The set of addresses may be entered in a separate user interface (not shown).

Demographic input element 306 may be used to set one or more demographic criteria as a matching rule. For example, an age occupation, marital status, may be demographics categories to use. The level of demographic details that may be used may be limited to those categories in which a goal user has authorized such information to be divulged. Accordingly, if a user does not share certain characteristics (such as their marital status) the defined criterion may be ignored for matching purposes. In various examples, the sponsored user may indicate that if the user has not authorized such information to be used for matching purposes, then no match should be made. In the case of interface 200, the sponsor user has indicated the matching rule to be an age range of 20-24. More than one demographic criterion may be set by a sponsor user.

Minimum amount input element 308 may be used to set matching criteria with that corresponds to total amount input element 208. Thus, the sponsor entity may not be matched to a goal unless the savings amount is at least equal to the value of minimum amount input element 308. Difficulty selection input element 310 may be used to select a difficulty level of the goal as determined by application server 102 (as described above) the selected difficulty level. An additional setting may indicate if the difficulty level needs to be a precise match, a range, or a threshold (either above or below).

Auto-sponsor preference element 312 may be used to determine if a match should automatically be made should the criterion be met by a goal or if a manual acceptance is needed. For example, if matching component 128 determines there is a match, a notification may be transmitted to an e-mail address to notify the sponsor entity that a match has been made. In various examples, application server 102 includes a user interface for the sponsor entity that lists matches that have been made, but that have not been automatically approved—at which point a sponsor unit can accept or decline the match. Save element 316 may be used to save the information entered into interface 300 as a sponsor rule in a sponsor data structure.

Sponsor graphic 314 may be used to display the current sponsor graphic for the logged in sponsor user. Although not depicted, a sponsor user may use interface 300 to update the sponsor graphic (e.g., upload a new graphic), which may be stored as part of a sponsor data structure.

FIG. 4 is a goal status user interface, according to various examples. The interface 400 comprises a savings goal progress visualization 402, a savings goal progress visualization 404, a savings goal progress visualization 406, a milestone marker 408, a milestone marker 410, a milestone marker 412, a current progress value 414, a sponsor graphic 416, an achieved award graphic 418, a link to award 420, and a new goal element 422.

An interface such as interface 400 may be presented based on a goal user clicking on a link or button presented in an account overview page. For example, an account overview page may include balance information of the financial accounts a user has at a financial institution. As a subheading under a savings account, a list of the current goals of the user may be presented. A link in this section may be used to take the user (e.g., open a new webpage) to interface 400. In other examples, interface 400 may be part of its own application or as part of the account overview page itself.

User interface compositor 124 may be used to generate interface 400. For example, user interface compositor 124 may query data store 118 for goals that have been created by the user. For each goal, user interface compositor 124 may parse the associated goal data structure to determine if the goal was sponsored (e.g., by checking value of a sponsor Bool). For each goal that is sponsored, a sponsor graphic may be accessed. For example, the goal data structure may identify the sponsor identifier, which may be used to access a sponsor data structure and the associated graphic. The goal data structures may also be parsed to retrieve a status of the goal (e.g., how much has been saved, how many weeks a user has saved, etc.) and milestone amounts. New goal element 422 may also be presented. If activated, a user interface such as interface 200 in FIG. 2 may be presented to the user.

User interface compositor 124 may then generate a visualization, such as savings goal progress visualization 402, by accessing visualization preferences and rules. For example, the graphic shape used may be stored as a preference of the user or setting in application server 102. In the case of FIG. 4, the graphic shape is a ring. To generate the graphic shape, user interface compositor 124 may call an API of the presentation environment. For example, if HTML5 is used, the arc ( ) method may be used to draw the outer and inner portions of the arc.

The graphic shape may be filled in (e.g., using another API call) according to the current status of the goal and display the amount saved, represented by current progress value 414. For example, as seen in savings goal progress visualization 402, the current progress value 414 is $2,150 and the ring shown is shaded up until that point. Additionally, milestone marker 408 is presented on savings goal progress visualization 402, which corresponds to a milestone amount of the goal data structure. Finally, sponsor graphic 416 is placed in the center of the ring, which corresponds to the sponsor graphic of the sponsor identifier in the goal data structure.

Savings goal progress visualization 404 and savings goal progress visualization 406 may be similarly generated. For example, savings goal progress visualization 404 indicates that, instead of a dollar amount, the goal is to save for a certain number of weeks. Accordingly, milestone marker 410 identifies “20 weeks of savings.” Savings goal progress visualization 406 includes two milestone markers, milestone marker 412 and current progress value 414.

When a goal milestone amount has been reached, application server 102 may receive an electronic link to an award that was given to the user. An award may be a coupon, etc., associated with the sponsor. As part of interface 400, the link may be included (e.g., link to award 420) along with achieved award graphic 418.

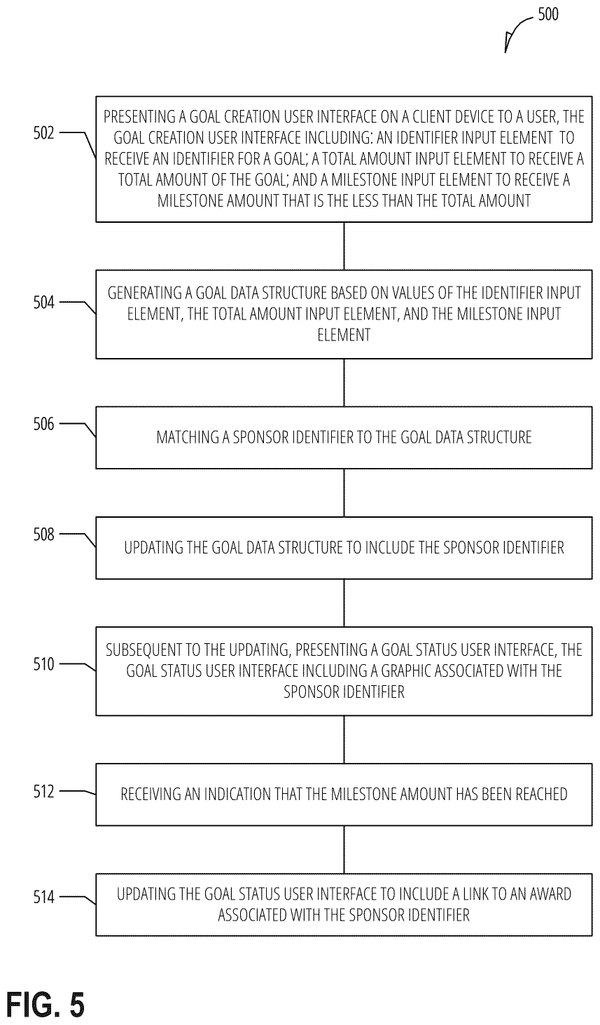

FIG. 5 is a flowchart 500 illustrating a method to match goals and sponsors, according to various examples. The method is represented as a set of blocks that describe operations 502 to 514. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 5. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

In various examples, operation 502 of the method includes presenting a goal creation user interface on a client device to a user. The goal creation user interface may include a label input element configured to receive an identifier for a goal, a total amount input element configured to receive a total amount of the goal, and a milestone input element configured to receive a milestone amount that is the less than the total amount. For example, the goal creation user interface may be one such as presented in FIG. 2.

The method may also include where the goal status user interface further includes an authorization element to allow an obfuscated set of information in the goal data structure to be accessed by a plurality of sponsors for matching purposes. The method may also include where the obfuscated set of information in the goal data structure includes a geographic region. The method may also include where the obfuscated set of information in the goal data structure includes a goal range that is determined according to the milestone amount. Data transformation component 130 may be used to generate obfuscated information and store it as part of the goal data structure.

In various examples, operation 504 of the method includes generating a goal data structure based on values of the label input element, the total amount input element, and the milestone input element. For example, goal component 126 may generate the data structure and store it in data store 118 with the values entered into the input elements.

In various examples, operation 506 of the method includes matching, using a processing unit, a sponsor identifier to the goal data structure. For example, logic such as described for matching component 128 may be used to match the sponsor identifier to the goal data structure. In various examples, operation 508 of the method includes updating the goal data structure to include the sponsor identifier.

The method may also include where matching the sponsor identifier to the goal data structure includes querying an entity database (e.g., sponsor data structures 134) to determine the subset of information meets sponsoring criteria for the sponsor identifier.

In various examples, operation 510 of the method includes subsequent to the updating, presenting a goal status user interface, the goal status user interface including a graphic associated with the sponsor identifier. The goal status user interface may be an interface such as presented in FIG. 4. For example, user interface compositor 124 may be used as described above to place the sponsor graphic in the center of the graphic shape.

In various examples, operation 512 of the method includes receiving an indication that the milestone amount has been reached. For example, goal component 126 may track—by periodically checking the associated goal data structure—if an amount currently saved meets the milestone amount.

In various examples, operation 514 of the method includes updating the goal status user interface to include a link to an award associated with the sponsor identifier. For example, user interface compositor 124 may be used as described above to add an award graphic and a link to the award as described above.

The method may also include presenting a goal matching user interface configured to receive the sponsoring criteria. The sponsoring criteria may include a location.

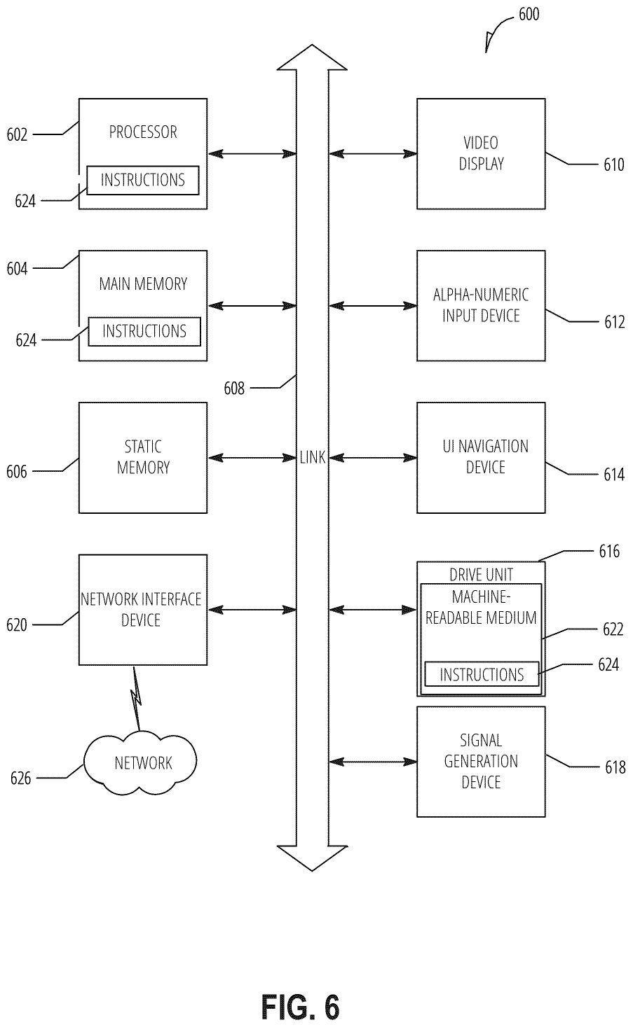

FIG. 6 is a block diagram illustrating a machine in the example form of computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608. The computer system 600 may further include a video display unit 610, an input device 612 (e.g., a keyboard), and a user interface (UI) navigation device 614 (e.g., a mouse). In one embodiment, the video display unit 610, input device 612, and UI navigation device 614 are incorporated into a single device housing such as a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensors.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 100, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed Database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 622 that excluded transitory signals.

The instructions 624 may further be transmitted or received over a communications network 626 using a transmission medium via the network interface device 620 utilizing any one of a number of well-known transfer protocols (e.g., HTTP). Examples of communication networks include a local area Network (LAN), a wide area Network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method comprising:
presenting, using a processing unit, a goal creation user interface on a client device to a user, the goal creation user interface including:
a label input element configured to receive an identifier for a goal;
a total amount input element configured to receive a total amount of the goal;
a milestone input element configured to receive a milestone amount that is less than the total amount; and
an authorization input element configured to receive authorization to allow an obfuscated set of information in a goal data structure to be accessed by a plurality of sponsors, the obfuscated set of information in the goal data structure includes a goal range that is determined according to the milestone amount;
generating, using the processing unit, the goal data structure based on values of the label input element, the total amount input element, the authorization input element, a user identifier associated with the user, and the milestone input element;
transforming, using the processing unit, a portion of data in the goal data structure to the obfuscated set of information;
virtually segmenting, using the processing unit, a user account associated with the user identifier to create a virtual account for the goal;
updating, using the processing unit, the user account in a database with data in the goal data structure;
matching, using the processing unit, a sponsor identifier to the goal data structure;
updating, using the processing unit, the goal data structure to include the sponsor identifier;
subsequent to the updating, querying a data store for a plurality of goal data structures associated with the user identifier;
presenting, using the processing unit, a goal status user interface, the goal status user interface including, for each respective goal data structure in the plurality of goal data structures:
a goal visualization; and
a graphic associated with a sponsor identifier in the respective goal data structure;
periodically checking, using the processing unit, an amount in the virtual account for the goal;
in response to the periodic checking, transmitting an application programming interface call to determine if the milestone amount has been reached;
receiving an indication that the milestone amount has been reached for the goal; and
subsequent to the receiving, updating, using the processing unit, the goal status user interface to include, for a goal visualization associated with the generated goal data structure, a link to an award associated with the sponsor identifier of the generated goal data structure.

2. (canceled)

3. The method of claim 1, wherein the obfuscated set of information in the goal data structure includes a geographic region.

4. (canceled)

5. The method of claim 1, wherein matching the sponsor identifier to the goal data structure includes:
querying an entity database to determine the obfuscated set of information meets sponsoring criteria for the sponsor identifier.

6. The method of claim 5, further comprising:
presenting a goal matching user interface configured to receive the sponsoring criteria.

7. The method of claim 5, wherein the sponsoring criteria includes a location.

8. A non-transitory computer-readable medium comprising instructions, which when executed by a processing unit, configure the processing unit to perform operations comprising:
presenting a goal creation user interface on a client device to a user, the goal creation user interface including:
a label input element configured to receive an identifier for a goal;
a total amount input element configured to receive a total amount of the goal;
a milestone input element configured to receive a milestone amount that is less than the total amount; and
an authorization input element configured to receive authorization to allow an obfuscated set of information in a goal data structure to be accessed by a plurality of sponsors, the obfuscated set of information in the goal data structure includes a goal range that is determined according to the milestone amount;
generating the goal data structure based on values of the label input element, the total amount input element, the authorization input element, a user identifier associated with the user, and the milestone input element;
transforming a portion of data in the goal data structure to the obfuscated set of information;
virtually segmenting a user account associated with the user identifier to create a virtual account for the goal;
updating the user account in a database with data in the goal data structure;
matching a sponsor identifier to the goal data structure;
updating the goal data structure to include the sponsor identifier;
subsequent to the updating, querying a data store for a plurality of goal data structures associated with the user identifier;
presenting a goal status user interface, the goal status user interface including, for each respective goal data structure in the plurality of goal data structures:
a goal visualization; and
a graphic associated with a sponsor identifier in the respective goal data structure;
periodically checking an amount in the virtual account for the goal;
in response to the periodic checking, transmitting an application programming interface call to determine if the milestone amount has been reached;
receiving an indication that the milestone amount has been reached for the goal; and
subsequent to the receiving, updating the goal status user interface to include, for a goal visualization associated with the generated goal data structure, a link to an award associated with the sponsor identifier of the generated goal data structure.

9. (canceled)

10. The non-transitory computer-readable medium of claim 8, wherein the obfuscated set of information in the goal data structure includes a geographic region.

11. (canceled)

12. The non-transitory computer-readable medium of claim 8, wherein matching the sponsor identifier to the goal data structure includes:
querying an entity database to determine the obfuscated set of information meets sponsoring criteria for the sponsor identifier.

13. The non-transitory computer-readable medium of claim 12, wherein the instructions, which when by the processing unit, further configure the processing unit to perform operations comprising:
presenting a goal matching user interface configured to receive the sponsoring criteria.

14. The non-transitory computer-readable medium of claim 12, wherein the sponsoring criteria includes a location.

15. A system comprising:
a processing unit; and
a storage device comprising instructions, which when executed by the processing unit, configure the system to perform operations comprising:
presenting a goal creation user interface on a client device to a user, the goal creation user interface including:
a label input element configured to receive an identifier for a goal;
a total amount input element configured to receive a total amount of the goal;
a milestone input element configured to receive a milestone amount that is less than the total amount; and
an authorization input element configured to receive authorization to allow an obfuscated set of information in a goal data structure to be accessed by a plurality of sponsors, the obfuscated set of information in the goal data structure includes a goal range that is determined according to the milestone amount;
generating the goal data structure based on values of the label input element, the total amount input element, the authorization input element, a user identifier associated with the user, and the milestone input element;
transforming a portion of data in the goal data structure to the obfuscated set of information;
virtually segmenting a user account associated with the user identifier to create a virtual account for the goal;
updating the user account in a database with data in the goal data structure;
matching a sponsor identifier to the goal data structure;
updating the goal data structure to include the sponsor identifier;
subsequent to the updating, querying a data store for a plurality of goal data structures associated with the user identifier;
presenting a goal status user interface, the goal status user interface including, for each respective goal data structure in the plurality of goal data structures:
a goal visualization; and
a graphic associated with a sponsor identifier in the respective goal data structure;
periodically checking an amount in the virtual account for the goal;
in response to the periodic checking, transmitting an application programming interface call to determine if the milestone amount has been reached;
receiving an indication that the milestone amount has been reached for the goal; and
subsequent to the receiving, updating the goal status user interface to include, for a goal visualization associated with the generated goal data structure, a link to an award associated with the sponsor identifier of the generated goal data structure.

16. (canceled)

17. The system of claim 15, wherein the obfuscated set of information in the goal data structure includes a geographic region.

18. (canceled)

19. The system of claim 15, wherein matching the sponsor identifier to the goal data structure includes:
querying an entity database to determine the obfuscated set of information meets sponsoring criteria for the sponsor identifier.

20. The system of claim 19, wherein the instructions, which when by the processing unit, further configure the system to perform operations comprising:
presenting a goal matching user interface configured to receive the sponsoring criteria.
